(19) United States
(12) Patent Application Publication
(10) Pub. No.: US 2019/0243175 A1
(43) Pub. Date: Aug. 8, 2019

(54) MULTI-DISPLAY SYSTEM WITH BLACK MASK REDUCTION

(71) Applicant: PURE DEPTH, INC., Redwood City, CA (US)

(72) Inventor: John D. NEWTON, Auckland (NZ)

(21) Appl. No.: 16/261,929

(22) Filed: Jan. 30, 2019

Related U.S. Application Data
(60) Provisional application No. 62/625,661, filed on Feb. 2, 2018.

(51) Int. Cl. G02F 1/1347; G09G 3/36; G02F 1/1335; G02F 1/1343; G02F 1/1362; G02F 1/1368; G02F 1/1333

(52) U.S. Cl. CPC G02F 1/1347; G09G 3/36; G02F 1/133514; G02F 1/133512; G02F 1/134363; G02F 2201/121; G02F 1/1368; G02F 1/13338; G02F 1/133528; G09G 2300/023; G02F 2203/66; G02F 1/136286

(57) ABSTRACT

The multi-layer display system may include a plurality of display panels arranged in an overlapping manner, a backlight configured to provide light to the plurality of display panels, and a processing system. Each of the display panels may include an array of pixels. One or more of the display panels may be provided with a black mask and one or more of the display panels may be provided without a black mask to increase the transmissivity of the multi-layer display. The processing system may be configured to control the display of different content on the plurality of display panels.

### CROSS REFERENCE TO RELATED APPLICATION

This patent application claims priority to and the benefit of U.S. Provisional Application No. 62/625,661, filed on Feb. 2, 2018, which is hereby incorporated herein by reference in its entirety.

### FIELD OF THE INVENTION

The invention relates generally to multi-layer displays and, more particularly, to multi-layer displays including one or more display panels with a filter structure that increases the panel transmittance.

### BACKGROUND

Image displays limited to a single two dimensional display lack depth information. To relay depth information of displayed content (e.g., text, images, graphics) there have been efforts to provide displays that can display the content in three-dimensions. For example, stereo displays convey depth information by displaying offset images that are displayed separately to the left and right eye. However, stereo displays are limited from what angle the images can be viewed.

Multi-layer displays have been developed to display content with a realistic perception of depth due to displacement of stacked displays screens. However, overlapping display panels and other layers (e.g., filters and polarizers) in the multi-layer displays reduce the transmissivity of the multi-layer display. A backlight can be controlled to increase the brightness provided to the overlapping display panels. However, the increasing brightness of the backlight may still not provide the needed light to all of the display panels and increasing the brightness of the backlight consumes more power.

### SUMMARY

Exemplary embodiments of this disclosure provide a display system that can display content on different display screens of a multi-layer display provided in a stacked arrangement. The multi-layer display system may include a plurality of display panels arranged in an overlapping manner, a backlight configured to provide light to the plurality of display panels, and a processing system. Each of the display panels may include an array of pixels. One or more of the display panels may be provided with a black mask and one or more of the display panels may be provided without a black mask to increase the transmissivity of the multi-layer display. The multi-layer display may further comprise a pair of crossed polarized layers. The processing system may be configured to control the display of different content on the plurality of display panels.

According to one exemplary embodiment, an instrument panel comprises a multi-layer display including a front display panel, a rear display panel arranged in a substantially parallel manner, a first polarized layer provided in front of and adjacent to the front display panel, and a second polarized layer provided behind and adjacent to the rear display panel, the front display panel and the rear display panel including an array of pixels, the front display panel includes a black mask defining openings of the array of pixels and the rear display panel is provided without a black mask; a backlight configured to provide light to the front display panel and the rear display panel of the multi-layer display; and a processing system comprising at least one processor and memory, the processing system configured to control the front display panel to display a first content and control the rear display panel to display a second content.

In another exemplary embodiment, the front display panel further includes a first color filter layer including red, green, and blue filters and the black mask is provided at least partially in the first color filter layer between the red, green, and blue filters of the first color filter layer and defines openings of liquid crystal display cells in the front display panel.

In another exemplary embodiment, the rear display panel further includes a second color filter layer including red, green, and blue filters and a transparent mask without color filter attenuation between the red, green, and blue filters of the second color filter layer.

In another exemplary embodiment, the front display panel includes a plurality of liquid crystal display cells and a first filter layer comprising red, green, and blue filters defining red, green, and blue pixels respectively, the rear display panel includes a plurality of liquid crystal display cells and a second filter layer comprising red, green, and blue filters defining red, green, and blue pixels, respectively, and wherein active regions of the liquid crystal display cells in the front display panel are larger than active regions of the liquid crystal display cells in the rear display panel.

In another exemplary embodiment, the rear display panel includes a plurality of liquid crystal display cells and a filter layer comprising red, green, and blue filters defining red, green, and blue pixels, respectively, a common electrode provided on a side of the liquid crystal display cells opposite to the side including the filter layer, and wherein the common electrode is disposed between the liquid crystal display cells and data and gate lines coupled to thin film transistors.

In another exemplary embodiment, the front display panel and the rear display panel are multi-domain in-plane-switching liquid crystal displays.

In another exemplary embodiment, at least one of the front display panel and the rear display panel includes a plurality passive white (W) sub-pixels.

In another exemplary embodiment, the first content is displayed such that at least a portion of the first content overlaps the second content displayed on the rear display panel, and at least a portion of the first content is displayed without overlapping the second content.

In another exemplary embodiment, the front display panel is a touch sensitive display, and the processing system is configured to detect whether a touch input is performed to a portion of the front display panel displaying the first content.

In another exemplary embodiment, multi-layer display system, comprises: a first display and a second display arranged in a substantially parallel manner to the first display, the first display overlapping the second display, the first display including a plurality of liquid crystal display cells and a first filter layer comprising red, green, and blue filters defining red, green, and blue pixels respectively, the second display including a plurality of liquid crystal display cells and a second filter layer comprising red, green, and blue filters defining red, green, and blue pixels, respectively, wherein the first filter layer includes an opaque mask provided between the red, green, and blue filters of the first filter layer and defining openings of the liquid crystal display cells, and the second filter layer includes a transparent mask without color filter attenuation provided between the red, green, and blue filters of the second filter layer; a light source configured to provide light to the first display and the second display; a first polarized layer provided in front of and adjacent to the first display; a second polarized layer provided between the light source and the second display; and a processing system comprising at least one processor and memory, the processing system configured to: display first content on the first display, and display second content on the second display.

In another exemplary embodiment, active regions of the red, green, and blue pixels in the first display are larger than active regions of the red, green, and blue pixels in the second display.

In another exemplary embodiment, the liquid crystal display cells are multi-domain liquid crystal display cells including multiple liquid crystal director rotation directions.

In another exemplary embodiment, the first content is displayed such that at least a portion of the first content overlaps the second content displayed on the second display, and at least a portion of the first content is displayed without overlapping the second content.

In another exemplary embodiment, the first display and the second display each include a plurality passive white (W) liquid crystal display cells.

In another exemplary embodiment, the second display includes a common electrode provided on a side of the liquid crystal display cells opposite to the side adjacent to the second filter layer, and wherein the common electrode is disposed between the liquid crystal display cells and data and gate lines coupled to thin film transistors.

In another exemplary embodiment, the first display includes a common electrode provided on a side of the liquid crystal display cells opposite to the side including the first filter layer, and wherein the common electrode in the first display is disposed between the liquid crystal display cells of the first display and data and gate lines coupled to thin film transistors of the first display.

In another exemplary embodiment, an instrument panel comprises; a multi-layer display including a plurality of display panels arranged in a substantially parallel manner, the plurality of display panels including a rear display panel and a front display panel overlapping the rear display panel, each of the display panels including active red (R) sub-pixels, active green (G) sub-pixels, and active blue (B) sub-pixels, wherein active regions of the red (R) sub-pixels, green (G) sub-pixels, and blue (B) sub-pixels of the front display panel are larger than active regions of the red (R) sub-pixels, green (G) sub-pixels, and blue (B) sub-pixels of the rear display panel; the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel; a backlight configured to provide light to the front display panel and the rear display panel of the multi-layer display; and a processing system comprising at least one processor and memory, the processing system configured to simultaneously display content on the plurality of display panels.

In another exemplary embodiment, at least one of the plurality of display panels is a monochrome panel.

In another exemplary embodiment, each of the plurality of display panels includes a color filter layer defining regions of the red (R) sub-pixels, active green (G) sub-pixels, and active blue (B) sub-pixels, and at least one of the plurality of display panels is provided without a black mask in color filter layer.

In another exemplary embodiment, the front display panel includes an opaque mask defining the active regions of the red (R) sub-pixels, green (G) sub-pixels, and blue (B) sub-pixels of the front display panel, and the rear display panel includes a transparent mask defining the active regions of the red (R) sub-pixels, green (G) sub-pixels, and blue (B) sub-pixels of the rear display panel.

In another exemplary embodiment, only the front display panel of the plurality of display panels includes a black mask defining the active regions of the red (R) sub-pixels, green (G) sub-pixels, and blue (B) sub-pixels of the front display panel.

### BRIEF DESCRIPTION OF THE DRAWINGS

So that features of the present invention can be understood, a number of drawings are described below. It is to be noted, however, that the appended drawings illustrate only particular embodiments of the invention and are therefore not to be considered limiting of its scope, for the invention may encompass other equally effective embodiments.

FIG. 1 illustrates a multi-layer display system according to an embodiment of the present disclosure.

FIG. 2 illustrates top view and perspective view of an in-plane switching mode liquid crystal display device (IPS-LCD) cell in an off state and an on state.

FIG. 3 illustrates a MLD according to an example embodiment of this invention, in which the stacked overlapping layers/displays of any of the figures herein may be provided and utilized.

FIG. 4A illustrates color filter layers of a stacked overlapping layers/displays in a MLD system with each layer including a black mask.

FIG. 4B illustrates color filter layers of a stacked overlapping layers/displays in a MLD system with one layer provided without a black mask.

FIG. 5 shows a table with sample values illustrating improvements that can be provided by using MLD systems according to the embodiments disclosed in this application.

FIG. 6 illustrates a cross section of an IPS-Pro pixel.

FIG. 7 illustrates a cross section of an IPS-Pro-Next pixel.

FIG. 8 illustrates an exemplary microscope image of a TFT layer.

FIG. 9 illustrates an exemplary processing system upon which various embodiments of the present disclosure(s) may be implemented.

### DETAILED DESCRIPTION

Embodiments of this disclosure provide for using a multi-layer display system including a plurality of display panels, with each display panel including a plurality of liquid crystal display cells. Content (e.g., graphics, texts etc.) is displayed on a plurality of the panels simultaneously with at least a portion of the content displayed one panel overlapping content displayed on another panel. As explained in this disclosure, the plurality of display panels in the multi-layer display (MLD) may cause a reduction in the luminance of the systems and/or require additional power to increase light generated by a backlight. To overcome these challenges, embodiments of this disclosure provide for reducing the size of and/or removing a black mask from one or more the display panels.

In MLD system with a pair of crossed polarized layers, the light transmitted through the displays is not analyzed until it reaches the front polarizer. Accordingly, light from the rear polarizer transfers through the regions of one display (e.g., a rear LCD) and then through regions of another display (e.g., a front LCD) before reaching the front polarizer. Regions in an overlapped display (e.g., a rear display) that have an opaque mask (e.g., a black mask) may block some of the light from reaching other display(s). Accordingly, the opaque mask in an overlapped display may be replaced with a transparent mask to allow back light to reach the other display(s) (e.g., a front display). In some embodiments, the size of the active pixel regions in overlapped display may be reduced to allow for larger transparent mask to be included in a filter layer of the overlapped display.

The transmission efficiency of MLD is the product of the transmission of the separate LC panels and the polarizers. Any increase in the transmission of any component will increase the overall transmission.

The removal of the black mask from one panel increases the transmission through the other panel thus increasing the overall transmission of the MLD. The opening up of the black mask in practice opens up ˜10% more pixel aperture. This aperture is free of color filter and has higher transmission. This extra light flux is available for processing by the second panel and will increase transmittance of this panel.

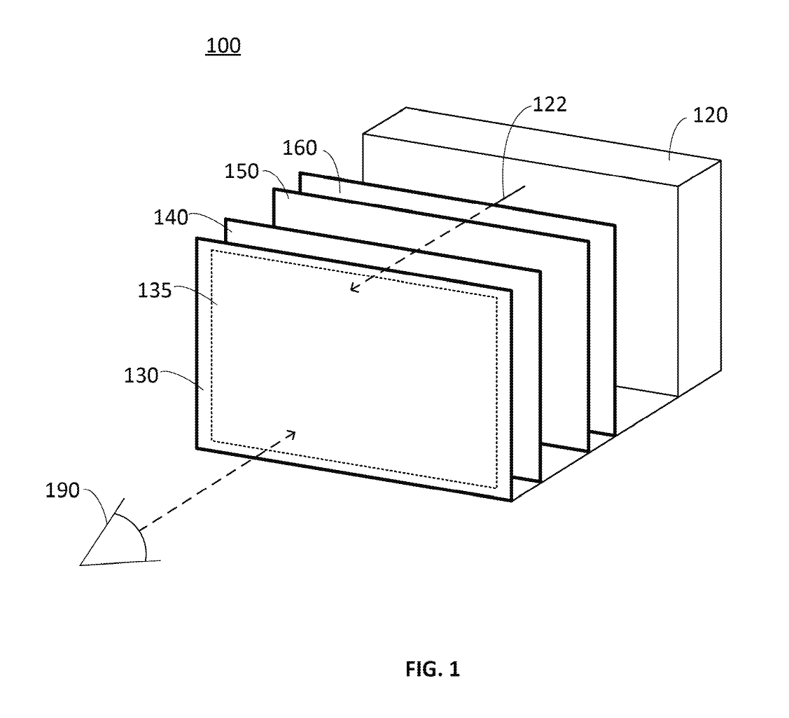

FIG. 1 illustrates a multi-layer display system 100 according to an embodiment of the present disclosure. The display system 100 may include a light source 120 (e.g., rear mounted light source, side mounted light source, optionally with a light guide), and a plurality of display screens 130-160. Each of the display screens 130-160 may include multi-domain liquid crystal display cells. One or more of the display screens 130-160 may include a black mask and/or other non-reflective material defining the visible parts of the liquid crystal display cells. One or more of the display screens 130-160 may be provided without a black mask and/or other non-reflective material. In one example, only a front display screen 130 may include a black mask and/or other non-reflective material, while the display screens behind the front display screen 130 may be provided without a black mask and/or other non-reflective material.

The display screens 130-160 may be disposed substantially parallel or parallel to each other and/or a surface (e.g., light guide) of the light source 120 in an overlapping manner In one embodiment, the light source 120 and the display screens 130-160 may be disposed in a common housing. The display apparatus 100 may be provided in an instrument panel installed in a dashboard of a vehicle. The instrument panel may be configured to display information to an occupant of the vehicle via one or more displays 130-160 and/or one or more mechanical indicators provided in the instrument panel. One or more of the mechanical indicators may be disposed between the displays 130-160. The displayed information using the displays 130-160 and/or the mechanical indicators may include vehicle speed, engine coolant temperature, oil pressure, fuel level, charge level, and navigation information, but is not so limited. It should be appreciated that the elements illustrated in the figures are not drawn to scale, and thus, may comprise different shapes, sizes, etc. in other embodiments.

The light source 120 may be configured to provide illumination for the display system 100. The light source 120 may provide substantially collimated light 122 that is transmitted through the display screens 130-160.

Optionally, the light source 120 may provide highly collimated light using high brightness LED's that provide for a near point source. The LED point sources may include pre-collimating optics providing a sharply defined and/or evenly illuminated reflection from their emission areas. The light source 120 may include reflective collimated surfaces such as parabolic mirrors and/or parabolic concentrators. In one embodiment, the light source 120 may include refractive surfaces such as convex lenses in front of the point source. However, the LEDs may be edge mounted and direct light through a light guide which in turn directs the light toward the display panels in certain example embodiments. The light source 120 may comprise a plurality of light sources, with each light source providing backlight to a different region of the display screens 130-160. In one embodiment, the light source 120 may be configured to individual provide and control light for each pixels of a panel in front of the light source 120.

Each of the display panels/screens 130-160 may include a liquid crystal display (LCD) matrix. Alternatively, one or more of the display screens 130-160 may include organic light emitting diode (OLED) displays, transparent light emitting diode (TOLED) displays, cathode ray tube (CRT) displays, field emission displays (FEDs), field sequential display or projection displays. In one embodiment, the display panels 130-160 may be combinations of either full color RGB, RGBW or monochrome panels. Accordingly, one or more of the display panels may be RGB panels, one or more of the display panels may be RGBW panels and/or one or more of the display panels may be monochrome panels. One or more of the display panels may include passive white (W) sub-pixels. The display screens 130-160 are not limited to the listed display technologies and may include other display technologies that allows for the projection of light. In one embodiment, the light may be provided by a projection type system including a light source and one or more lenses and/or a transmissive or reflective LCD matrix. The display screens 130-160 may include a multi-layer display unit including multiple stacked or overlapped display layers each configured to render display elements thereon for viewing through the uppermost display layer.

In one embodiment, each of the display screens 130-160 may be approximately the same size and have a planar surface that is parallel or substantially parallel to one another. In another embodiment, one or more of the display screens 130-160 may have a curved surface. In one embodiment, one or more of the display screens 130-160 may be displaced from the other display screens such that a portion of the display screen is not overlapped and/or is not overlapping another display screen.

Each of the display screens 130-160 may be displaced an equal distance from each other in example embodiments. In another embodiment, the display screens 130-160 may be provided at different distances from each other. For example, a second display screen 140 may be displaced from the first display screen 130 a first distance, and a third display screen 150 may be displaced from the second display screen 140 a second distance that is greater than the first distance. The fourth display screen 160 may be displaced from the third display screen 150 a third distance that is equal to the first distance, equal to the second distance, or different from the first and second distances.

The display screens 130-160 may be configured to display graphical information for viewing by the observer 190. The viewer/observer 190 may be, for example, a human operator or passenger of a vehicle, or an electrical and/or mechanical optical reception device (e.g., a still image, a moving-image camera, etc.). Graphical information may include visual display content (e.g., objects and/or texts). The display screens 130-160 may be controlled to display content simultaneously on different display screens 130-160. At least a portion of content displayed on one of the display screens 130-160 may overlap content displayed on another one of the display screens 130-160.

In one embodiment, the graphical information may include displaying images or a sequence of images to provide video or animations. In one embodiment, displaying the graphical information may include moving objects and/or text across the screen or changing or providing animations to the objects and/or text. The animations may include changing the color, shape and/or size of the objects or text. In one embodiment, displayed objects and/or text may be moved between the display screens 130-160. The distances between the display screens 130-160 may be set to obtain a desired depth perception between features displayed on the display screens 130-160.

In one embodiment, a position of one or more of the display screens 130-160 may be adjustable by an observer 190 in response to an input. Thus, an observer 190 may be able to adjust the three dimension depth of the displayed objects due to the displacement of the display screens 130-160. A processing system may be configured to adjust the displayed graphics and gradients associated with the graphics in accordance with the adjustment.

Each of the display screens 130-160 may be configured to receive data and display, based on the data, a different image on each of the display screens 130-160 simultaneously. Because the images are separated by a physical separation due to the separation of the display screens 130-160, each image is provided at a different focal plane and depth is perceived by the observer 190 in the displayed images. The images may include graphics in different portions of the respective display screen.

While not illustrated in FIG. 1, the display system 100 may include one or more projection screens, one or more diffraction elements, and/or one or more filters between an observer 190 and the projection screen 160, between any two display screens 130-160, and/or the display screen 130 and the light source 120.

The display system 100 may include a touch sensitive display surface 135 provided in front of or as part of the front display 130. A processing system may be configured to detect whether a touch input is performed to a portion of the front display displaying the one or more objects, and/or display content based on the touch input(s).

One or more of the display screens 130-160 may be in-plane switching mode liquid crystal display devices (IPS-LCDs). The IPS-LCD may be a crossed polarizer type with a polarizer on one side of the cells being perpendicular to a polarizer on an opposite side of the cells (i.e., transmission directions of the polarizers are placed at right angles). In one embodiment, a pair of crossed polarized layers may be provided with a first polarizer layer provided in front of the display screen 130 and a second polarizer layer provided behind the display screen 160.

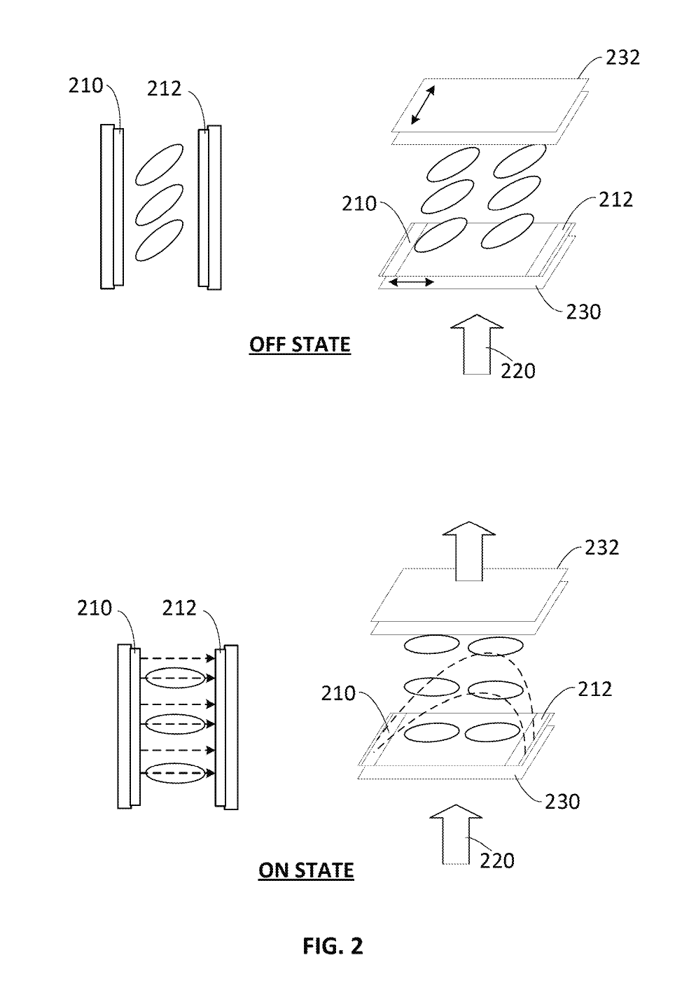

FIG. 2 illustrates top view and perspective view of an IPS-LCD cell in an off state and an on state. In the off state, without a voltage applied to electrodes 210 and 212, liquid crystal molecules in the cell have a uniform orientation at 45 degrees with the electrodes (the LC director is uniform throughout the cell). Polarized light 220 enters and exits the cell without a change in the polarization. The polarized light 220 will be blocked in the off state, if a polarizer 230 on one side of the cell is provided perpendicular to a polarizer 232 on an opposite side of the cell.

In the on state, a voltage is applied to the electrodes 210 and 212. The electric field drives the liquid crystal molecules to rotate in the plane of the substrate and orient along the field direction. The rotation of the molecules causes a phase change to the polarized light 220. The light 220 will be transmitted in the on state.

The transmission T of the light 220, in the on state of an IPS-LCD, can be described by:

$$T = {sin}^{2} ( 2 θ ( V ) ) * {sin}^{2} ( π \frac{Δ nd}{λ} ) ,$$

where θ(V) is the angle between polarizer and the LC director, and is a function of the applied voltage; An is the birefringence of cell, d is the cell gap, and λ is the wavelength. Δnd can be chosen so that the value is ˜0.3, hence the second term in the equation can be maximized for visible wavelengths. At V=0, the LC director is parallel to the polarizer, θ=0°, hence T=0. At high voltage, most of the molecules align along the electric field, θ=45°, hence T=1.

In one example, the display panels include multi-domain in-plane-switching liquid crystal displays. Displays with multi-domain cells provide an additional deviations from a basic model that is caused by liquid crystal director twist angles varying across the cell. Multi-domain in-plane-switching displays are designed to provide for smaller color shift in an off axis diagonal view, faster response time, wider viewing angle, higher contrast ratio, and/or higher optical efficiently. A multi-domain liquid crystal display cell includes multiple liquid crystal director rotation directions. The multiple rotation directions are provided by different electric fields in each portion of the cell.

The electrode structure may be optimized for peak transmittance, contrast and/or good off angle color. Balance of the three domains, RH twist, LH twist and “no Twist” is significant. The third domain is called “no twist” and model it this way, but it is an approximation to a varying twist over the volume of the cell. The specific electrode structure within the cell provides for the electric field in one portion of the cell to reorient the liquid crystal director in one direction, and the electric field in another portion of the cell to reorient different liquid crystal director in another direction. The electric field causes the liquid crystal directors to be twisted into opposite directions LH and RH to provide the dual-domain liquid crystal configuration.

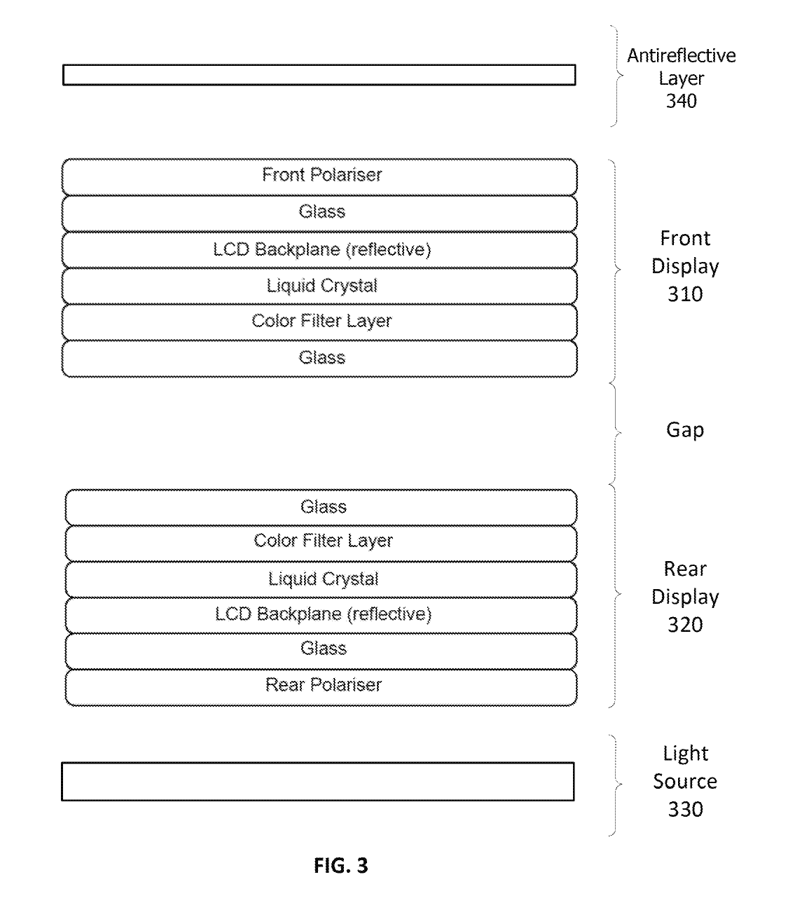

FIG. 3 illustrates a MLD according to an example embodiment of this invention, in which the stacked overlapping layers/displays of any of the figures herein may be provided and utilized. For example, the display screens 130 and 160 (shown in FIG. 1) may correspond the front display 310 and rear display 320 in FIG. 3, respectively.

The front display 310 may be a display that is closest to an observer. The rear display 320 may be a display that is closest to a light source 330 (e.g., backlight) of the MLD. While not illustrated in FIG. 3, one or more other components such as display layer(s), filter(s), and/or filler(s) may be provided in the gap between the front display 310 and the rear display 320.

The MLD includes a crossed polarizer type configuration with a polarizer on one side of the displays being perpendicular to a polarizer on an opposite side of the displays (i.e., transmission directions of the polarizers are placed at right angles). As shown in FIG. 3, a front polarizer is provided on the front of the front display 310 and a rear polarizer is provided on a back surface of the rear display 320. In one embodiment, the MLD may include only two polarizers provided between a plurality of overlapping liquid crystal layers of the displays 310 and 320 and any other liquid crystal layers provided in the gap.

Other polarizers may optionally be provided as part of an antireflective layer 340 (e.g., provided in front of the front display 310) to reduce external reflections of ambient light. The antireflective layer 340 may include a quarter wave retarder and/or an antireflective (AR) polarizer. Additionally, black mask (BM) or other non-reflective material may be added behind the conductive traces of the displays to reduce reflections. Additionally, antireflective (AR) coating(s) may be applied to the interior surfaces in certain example embodiments. The AR coating may, for example, operate in the visible range, e.g., moth eye, single layer interference, multi-layer interference, etc.

Gaps between the displays may be designed to include air or material having birefringence designed to maintain black state of the display when desired. The gap may include material having a refractive index matched closely to glass or the layers on either side to reduce internal reflection and/or depolarization effects. For the front display 310, its backplane may be oriented opposite to that of display 320. In particular, for the front display 310 its backplane may be oriented to face the viewer to reduce internal reflections.

As illustrated in FIG. 3, accordingly to one embodiment, the color filter layers (each of which may be made up of one or more layers) of the respective displays may be designed to face each other, with no liquid crystal layer from either display being located between the color filter layers of the first and second displays in certain example embodiments. The position of the color filter layers is not limited to the illustration in FIG. 3 and may be provided in other positions of the respective display. For example, the color filter of the front display 310 may be provided between the glass and the liquid crystal of the front display 310.

The displays may be comprised of pixels arranged in a matrix using an RGB (Red, Green, Blue) wavelength distribution. In this configuration, each pixel group is provided with Red, Green, and Blue colors. A given pixel provides one color image by mixing the red, green and blue light generated from the respective sub-pixels of the pixel. A back light generates light for the pixel, but the RGB pixel transmits only a portion of the light provided by the back light (e.g., 30% of the provided light). In some embodiments, one or more pixel groups may be provided with a liquid crystal without a color filter to provide a white pixel. The white pixel may be a passive pixel.

The color filter layer in one or more of the displays may include a black mask. The black mask may be opaque and define, at each pixel, apertures through which the liquid crystal pixels are visible. Light is transmitted and/or reflected through the apertures defined by the mask. The black mask may hide portions of the display(s) around the pixels and parts of the pixels where visible artifacts occur (e.g., fringing fields created between and/or at the edges of addressing electrodes of the pixels). The black mask may reduce the ambient light reflections from reflective gate and data lines of the display and be provided over transistors, glass spaces, and/or indium tin oxide (ITO) via connections.

To improve the gain in transmission of the MLD system, one or more displays may be provided with a black mask that is reduced or without a black mask. Reducing or removing the black mask in one of the displays will open the pixel aperture in one display to increase the transmission to one of more other displays. Displays without a black mask may include a transparent mask without color filter attenuation between the red, green, and blue filters of the filter layer. The color filter may include an organic resin that photo-imageable with a red, green or blue pigment. The pigment may be left out for the transparent mask or, in some embodiments, no mask placed in the white areas. Not having a mask in the white area may increase the LC cell gap in the corresponding region.

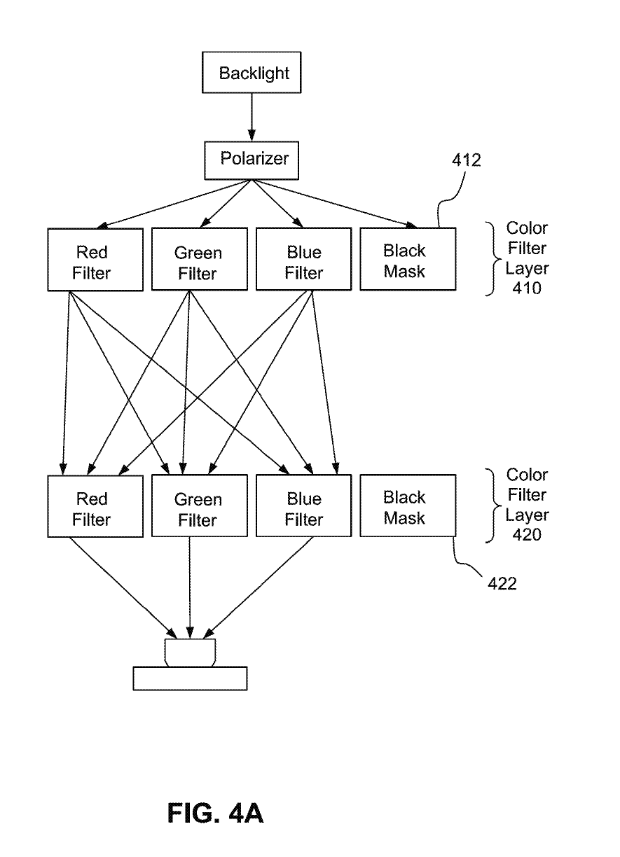

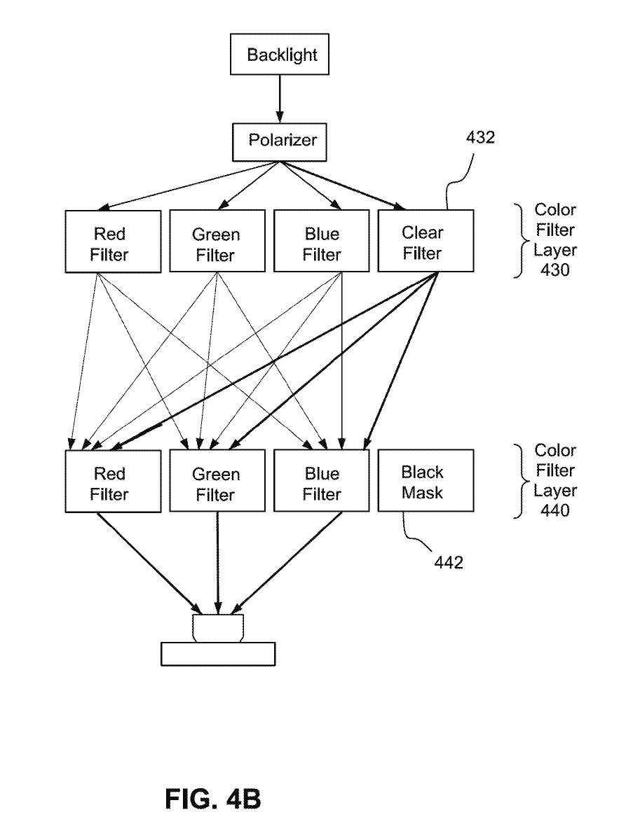

FIGS. 4A and 4B illustrate color filter layers of a stacked overlapping layers/displays in a MLD system. As illustrated in FIG. 4A, a first black mask 412 is included in a color filter layer 410 of a first display (e.g., a rear display) and a second black mask 422 is included in a color filter layer 420 of a second display (e.g., a front display). The first black mask 412 blocks light that is transmitted from the backlight to the first black mask 412 via the polarizer. The second black mask 422 blocks light that is transmitted from the backlight via the polarizer and the Red, Green, and Blue filters of the first display.

In FIG. 4B, a black mask 422 is included in a color filter layer 440 of a second display (e.g., a front display) and a color filter layer 430 of a first display (e.g., a rear display) is provided without a black mask. The color filter layer 430 of the first display includes Red, Green, and Blue filters and a clear filter 432 in regions of the color filter layer that would have otherwise included a black mask. The clear filter 430 may be a transparent mask without color filter attenuation provided between the red, green, and blue filters of the filter layer 430.

As illustrated in FIGS. 4A and 4B, light from the backlight that would have otherwise been blocked by a black mask 412 (shown in FIG. 4A) is transmitted via the clear filter 432 in the color filter 430 (shown in FIG. 4B). The black mask 442 in the second display blocks light that is transmitted from the backlight via the polarizer and/or the Red, Green, and Blue filters of the first display. The black mask in the second display may also block ambient light reflections (e.g., from reflective gate and data lines of the one or more displays).

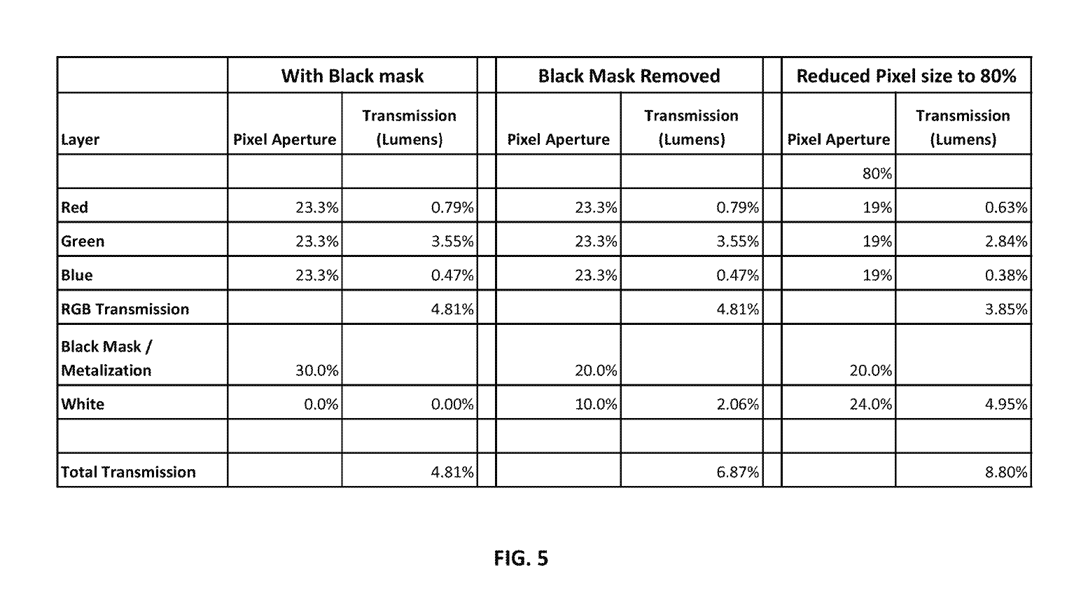

Removing the black mask from one panel increases the transmission through the other panel, thus increasing the overall transmission of the MLD system. FIG. 5 shows a table with sample values illustrating improvements that can be provided by using MLD systems according to the embodiments disclosed in this application. The table illustrates that the MLD effective transmission increase for a typical IPS panel when the black mask is removed. Opening up of the black mask may open up approximately 10% more pixel aperture. This aperture is free of color filter and has higher transmission. The extra light flux from opening up of the black mask is available for processing by a second panel and will increase the transmittance of the second panel.

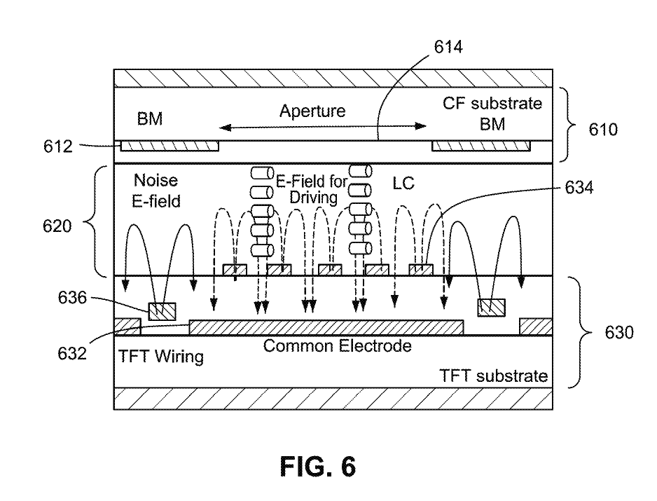

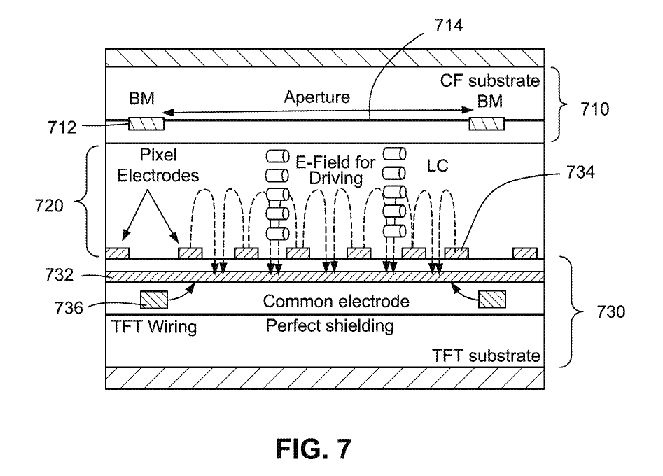

Removing a black mask in a display may increase ambient light reflections and/or visibility of artifacts (e.g., fringing fields created between and/or at the edges of addressing electrodes of the pixels). Certain LCD architectures may be used in the displays to reduce the artifacts. According to some exemplary embodiments, one or more of the displays in the MLD system may include IPS-Pro LCD technology and/or IPS-Pro-Next LCD technology. The IPS-Pro and IPS-Pro-Next LCD technology includes aperture architecture that provides for increases in the luminance over standard IPS technology and/or reduced artifacts in the pixels. FIG. 6 illustrates a cross section of an IPS-Pro pixel and FIG. 7 illustrates a cross section of an IPS-Pro-Next pixel.

The IPS-Pro pixel, illustrated in FIG. 6, includes two substrates with the liquid crystal located therebetween. A color filter layer 610 may be disposed above liquid crystal cells 620. The color filter layer 610 may include a black mask 612 and active regions 614 including color filters for respective liquid crystal cells disposed between portions of the black mask 612. The black mask 612 may define an aperture of the liquid crystal cells 620. A TFT substrate layer 630 may include the active matrix addressing electronics, for instance in the form of thin film transistor addressing circuitry and/or associated electrodes. An electric field for driving the liquid crystal cells may be generated between the common electrode 632 and the pixel electrodes 634. Noise electric fields may be present from the data and gate lines 636 of the TFT. The black mask 612 is provided to cover data and gate lines 636 and artifacts in the liquid crystal cells 620 caused by the noise electric fields.

An IPS-Pro-Next pixel, illustrated in FIG. 7, may be used to reduce the noise electric fields. As shown in FIG. 7, color filter layer 710 may be disposed above liquid crystal cells 720. The color filter layer 710 may include a black mask 712 and active regions 714 including color filters for respective liquid crystal cells disposed between portions of the black mask 712. The black mask 712 may define an aperture of the liquid crystal cells 720. A TFT substrate layer 730 may include the active matrix addressing electronics, for instance in the form of thin film transistor addressing circuitry and/or associated electrodes. An electric field for driving the liquid crystal cells may be generated between the common electrode 732 and the pixel electrodes 734. Noise electric fields may be reduced, as compared to the structure illustrated in FIG. 6, by providing a plane shaped common electrode 732 which covers the data and gate lines 736 of the TFT. Thus, the noise electric field coming from the data and gate lines 736 are shielded by the common electrode 732. The TFT substrate layer 730 may include an insulator that is provided between the data and gate lines 736 and the common electrode 732. The insulator may be an organic resin.

As illustrated in FIGS. 6 and 7, providing the data and gate lines below the common electrode reduces the noise electric fields in the liquid crystal cells 720 and allows for the size of the black mask 712 to be reduced. The reduction in the black mask 712 increases aperture of the liquid crystal cells and the light transmission. The transmission may be further increased by removing the black mask. A transparent mask may replace the black mask illustrated in FIG. 6 or 7.

The IPS-Pro-Next type LCD has the data and gate lines 736 below the common electrode 732 shielding them from the liquid crystal cell 720. This means that the black mask 712 is not needed to stop noise E field increasing off state light leakage, as shown in FIGS. 6 and 7. The purpose of the black mask on IPS-Pro-Next type LCD is mainly to reduce ambient light reflection from the reflective gate and data lines and is also over the transistors, glass spacers and ITO via connections.

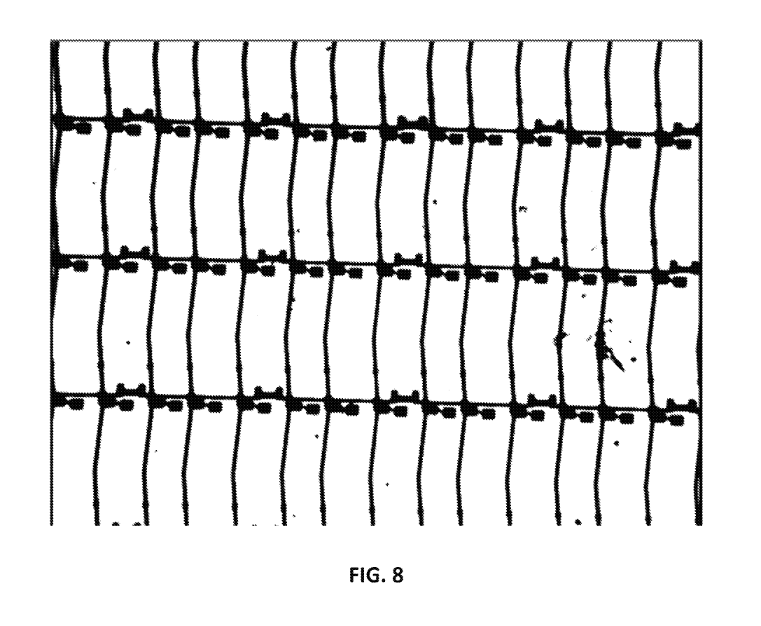

FIG. 8 illustrates an exemplary microscope image of a TFT layer. The TFT layer traditionally may be covered by a black mask that overlaps the TFT layer and extends to cover other portions of the pixel. Measurements show that the TFT conductive area and other structures are approximately 20% of the pixel area, and the black mask ˜30% of the pixel area. As shown in the Table illustrated in FIG. 5, removal of the black mask will open up another 10% of the pixel increasing transmission to the front panel by approximately 2.06%.

In addition, if the active pixel region is reduced to 80% of the original size with a corresponding increase in clear area then the overall transmission through the second panel is almost doubled to 8.8%. In one embodiment, one or more of the displays may include active pixel regions which are reduced as compared to the active region of one or more other displays. For example, a rear display may have active pixel regions which are reduced as compared to the active pixel regions of the front display (e.g., by 80%). Portions of the filter layer outside of the active pixel regions may be provided with a transparent material.

In one embodiment, a plurality of display panels may be provided in an overlapping manner behind a front display panel and each of the display panels behind the front display panel may include active pixel regions that are smaller than the active pixel regions of the front display panel.

MLD systems may suffer from pattern interference between two panels causing moire interference. When first and second displays or display layers are conventionally stacked on each other in a multi-display system, moire interference occurs. The moire interference is caused by interactions between the color filters within the layers when projected onto a viewer's retina. For example, when green color filters overlap, light is transmitted making for a comparative bright patch. When a green filter is over say a red filter, not as much light will be transmitted making for a dark region. Since the rear and front displays or display layers have slightly different sizes when projected onto the retina, the pixels will slowly change from being in phase to out of phase. This has the effect of producing dark and bright bands otherwise known as moire interference.

Removing the black mask may help reduce the moire interference, although color moire may still dominate. Certain elements may be added to the MLD system to make moiré interference in MLD systems vanish or substantially vanish, but without significantly sacrificing the rear display resolution and contrast. Moiré interference in MLD can be suppressed by adding a diffuser element between the back LCD and the observer so that the pixel structure in the back LCD is blurred. The greater the diffuser spread the less the moire but correspondingly the observed resolution of the back LCD is reduced. In certain embodiments, a beam mapping element such as diffractive optical element (DOE) or a refractive beam mapper (RBM) composed of many micro-lenses may be used to reduce moire interference. When an RBM is used, pseudo random mapping may be provided in order to not introduce extra moire effects. A refractive element such as RBM may be positioned on the top surface of the front display to reduce the color moire.

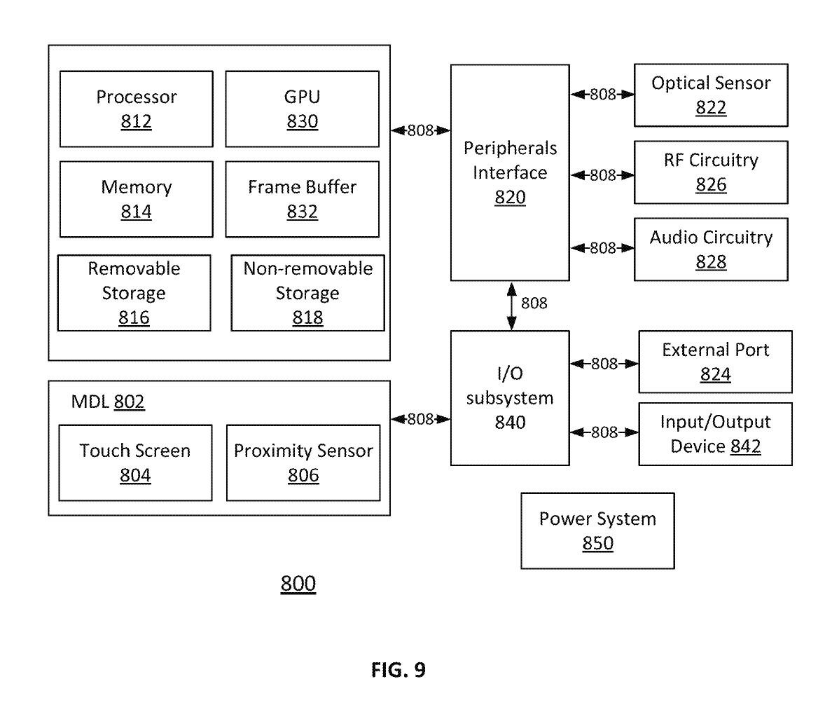

FIG. 9 illustrates an exemplary system 800 upon which embodiments of the present disclosure(s) may be implemented. The system 800 may be a portable electronic device that is commonly housed, but is not so limited. The system 800 may include a multi-layer display 802 including a plurality of overlapping displays. The multi-layer system may include a touch screen 804 and/or a proximity detector 806. The various components in the system 800 may be coupled to each other and/or to a processing system by one or more communication buses or signal lines 808.

The multi-layer display 802 may be coupled to a processing system including one or more processors 812 and memory 814. The processor 812 may comprise a central processing unit (CPU) or other type of processor. Depending on the configuration and/or type of computer system environment, the memory 814 may comprise volatile memory (e.g., RAM), non-volatile memory (e.g., ROM, flash memory, etc.), or some combination of the two. Additionally, memory 814 may be removable, non-removable, etc.

In other embodiments, the processing system may comprise additional storage (e.g., removable storage 816, non-removable storage 818, etc.). Removable storage 816 and/or non-removable storage 818 may comprise volatile memory, non-volatile memory, or any combination thereof Additionally, removable storage 816 and/or non-removable storage 818 may comprise CD-ROM, digital versatile disks (DVD) or other optical storage, magnetic cassettes, magnetic tape, magnetic disk storage or other magnetic storage devices, or any other medium which can be used to store information for access by processing system.

As illustrated in FIG. 9, the processing system may communicate with other systems, components, or devices via peripherals interface 820. Peripherals interface 820 may communicate with an optical sensor 822, external port 824, RC circuitry 826, audio circuity 828 and/or other devices. The optical sensor 882 may be a CMOS or CCD image sensor. The RC circuity 826 may be coupled to an antenna and allow communication with other devices, computers and/or servers using wireless and/or wired networks. The system 800 may support a variety of communications protocols, including code division multiple access (CDMA), Global System for Mobile Communications (GSM), Enhanced Data GSM Environment (EDGE), Wi-Fi (such as IEEE 802.11a, IEEE 802.11b, IEEE 802.11g and/or IEEE 802.11n), BLUETOOTH (BLUETOOTH is a registered trademark of Bluetooth Sig, Inc.), Wi-MAX, a protocol for email, instant messaging, and/or a short message service (SMS), or any other suitable communication protocol, including communication protocols not yet developed as of the filing date of this document. In an exemplary embodiment, the system 800 may be, at least in part, a mobile phone (e.g., a cellular telephone) or a tablet.

A graphics processor 830 may perform graphics/image processing operations on data stored in a frame buffer 832 or another memory of the processing system. Data stored in frame buffer 832 may be accessed, processed, and/or modified by components (e.g., graphics processor 830, processor 812, etc.) of the processing system and/or components of other systems/devices. Additionally, the data may be accessed (e.g., by graphics processor 830) and displayed on an output device coupled to the processing system. Accordingly, memory 814, removable 816, non-removable storage 818, frame buffer 832, or a combination thereof, may comprise instructions that when executed on a processor (e.g., 812, 830, etc.) implement a method of processing data (e.g., stored in frame buffer 832) for improved display quality on a display.

The memory 814 may include one or more applications. Examples of applications that may be stored in memory 814 include, navigation applications, telephone applications, email applications, text messaging or instant messaging applications, memo pad applications, address books or contact lists, calendars, picture taking and management applications, and music playing and management applications. The applications may include a web browser for rendering pages written in the Hypertext Markup Language (HTML), Wireless Markup Language (WML), or other languages suitable for composing webpages or other online content. The applications may include a program for browsing files stored in memory.

The memory 814 may include a contact point module (or a set of instructions), a closest link module (or a set of instructions), and a link information module (or a set of instructions). The contact point module may determine the centroid or some other reference point in a contact area formed by contact on the touch screen. The closest link module may determine a link that satisfies one or more predefined criteria with respect to a point in a contact area as determined by the contact point module. The link information module may retrieve and display information associated with selected content.

Each of the above identified modules and applications may correspond to a set of instructions for performing one or more functions described above. These modules (i.e., sets of instructions) need not be implemented as separate software programs, procedures or modules. The various modules and sub-modules may be rearranged and/or combined. Memory 814 may include additional modules and/or sub-modules, or fewer modules and/or sub-modules. Memory 814, therefore, may include a subset or a superset of the above identified modules and/or sub-modules. Various functions of the system may be implemented in hardware and/or in software, including in one or more signal processing and/or application specific integrated circuits.

Memory 814 may store an operating system, such as Darwin, RTXC, LINUX, UNIX, OS X, WINDOWS, or an embedded operating system such as VxWorks. The operating system may include procedures (or sets of instructions) for handling basic system services and for performing hardware dependent tasks. Memory 814 may also store communication procedures (or sets of instructions) in a communication module. The communication procedures may be used for communicating with one or more additional devices, one or more computers and/or one or more servers. The memory 814 may include a display module (or a set of instructions), a contact/motion module (or a set of instructions) to determine one or more points of contact and/or their movement, and a graphics module (or a set of instructions). The graphics module may support widgets, that is, modules or applications with embedded graphics. The widgets may be implemented using JavaScript, HTML, Adobe Flash, or other suitable computer program languages and technologies.

An I/O subsystem 840 may include a touch screen controller, a proximity controller and/or other input/output controller(s). The touch-screen controller may be coupled to a touch-sensitive screen or touch sensitive display system. The touch screen and touch screen controller may detect contact and any movement or break thereof using any of a plurality of touch sensitivity technologies now known or later developed, including but not limited to capacitive, resistive, infrared, and surface acoustic wave technologies, as well as other proximity sensor arrays or other elements for determining one or more points of contact with the touch-sensitive screen. A touch-sensitive display in some embodiments of the display system may be analogous to the multi-touch sensitive screens.

The other input/output controller(s) may be coupled to other input/control devices 842, such as one or more buttons. In some alternative embodiments, input controller(s) may be coupled to any (or none) of the following: a keyboard, infrared port, USB port, and/or a pointer device such as a mouse. The one or more buttons (not shown) may include an up/down button for volume control of the speaker and/or the microphone. The one or more buttons (not shown) may include a push button. The user may be able to customize a functionality of one or more of the buttons. The touch screen may be used to implement virtual or soft buttons and/or one or more keyboards.

In some embodiments, the system 800 may include circuitry for supporting a location determining capability, such as that provided by the Global Positioning System (GPS). The system 800 may include a power system 850 for powering the various components. The power system 850 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices. The system 800 may also include one or more external ports 824 for connecting the system 800 to other devices.

Portions of the present invention may be comprised of computer-readable and computer-executable instructions that reside, for example, in a processing system and which may be used as a part of a general purpose computer network (not shown). It is appreciated that processing system is merely exemplary. As such, the embodiment in this application can operate within a number of different systems including, but not limited to, general-purpose computer systems, embedded computer systems, laptop computer systems, hand-held computer systems, portable computer systems, stand-alone computer systems, game consoles, gaming systems or machines (e.g., found in a casino or other gaming establishment), or online gaming systems.

1. An instrument panel comprising;
a multi-layer display including a front display panel, a rear display panel arranged in a substantially parallel manner, a first polarized layer provided in front of and adjacent to the front display panel, and a second polarized layer provided behind and adjacent to the rear display panel, the front display panel and the rear display panel including an array of pixels, the front display panel includes a black mask defining openings of the array of pixels and the rear display panel is provided without a black mask;
a backlight configured to provide light to the front display panel and the rear display panel of the multi-layer display; and
a processing system comprising at least one processor and memory, the processing system configured to control the front display panel to display a first content and control the rear display panel to display a second content.

2. The instrument panel of claim 1, wherein the front display panel further includes a first color filter layer including red, green, and blue filters and the black mask is provided at least partially in the first color filter layer between the red, green, and blue filters of the first color filter layer and defines openings of liquid crystal display cells in the front display panel.

3. The instrument panel of claim 2, wherein the rear display panel further includes a second color filter layer including red, green, and blue filters and a transparent mask without color filter attenuation between the red, green, and blue filters of the second color filter layer.

4. The instrument panel of claim 1, wherein the front display panel includes a plurality of liquid crystal display cells and a first filter layer comprising red, green, and blue filters defining red, green, and blue pixels respectively, the rear display panel includes a plurality of liquid crystal display cells and a second filter layer comprising red, green, and blue filters defining red, green, and blue pixels, respectively, and wherein active regions of the liquid crystal display cells in the front display panel are larger than active regions of the liquid crystal display cells in the rear display panel.

5. The instrument panel of claim 1, wherein the rear display panel includes a plurality of liquid crystal display cells and a filter layer comprising red, green, and blue filters defining red, green, and blue pixels, respectively, a common electrode provided on a side of the liquid crystal display cells opposite to the side including the filter layer, and wherein the common electrode is disposed between the liquid crystal display cells and data and gate lines coupled to thin film transistors.

6. The instrument panel of claim 1, wherein the front display panel and the rear display panel are multi-domain in-plane-switching liquid crystal displays.

7. The instrument panel of claim 1, wherein at least one of the front display panel and the rear display panel includes a plurality passive white (W) sub-pixels.

8. The instrument panel of claim 1, wherein the first content is displayed such that at least a portion of the first content overlaps the second content displayed on the rear display panel, and at least a portion of the first content is displayed without overlapping the second content.

9. The instrument panel of claim 1, wherein the front display panel is a touch sensitive display, and the processing system is configured to detect whether a touch input is performed to a portion of the front display panel displaying the first content.

10. A multi-layer display system, comprising:
a first display and a second display arranged in a substantially parallel manner to the first display, the first display overlapping the second display, the first display including a plurality of liquid crystal display cells and a first filter layer comprising red, green, and blue filters defining red, green, and blue pixels respectively, the second display including a plurality of liquid crystal display cells and a second filter layer comprising red, green, and blue filters defining red, green, and blue pixels, respectively,
wherein the first filter layer includes an opaque mask provided between the red, green, and blue filters of the first filter layer and defining openings of the liquid crystal display cells, and the second filter layer includes a transparent mask without color filter attenuation provided between the red, green, and blue filters of the second filter layer;
a light source configured to provide light to the first display and the second display;
a first polarized layer provided in front of and adjacent to the first display;
a second polarized layer provided between the light source and the second display; and
a processing system comprising at least one processor and memory, the processing system configured to:
display first content on the first display, and
display second content on the second display.

11. The multi-layer display system of claim 10, wherein active regions of the red, green, and blue pixels in the first display are larger than active regions of the red, green, and blue pixels in the second display.

12. The multi-layer display system of claim 10, wherein the liquid crystal display cells are multi-domain liquid crystal display cells including multiple liquid crystal director rotation directions.

13. The multi-layer display system of claim 10, wherein the first content is displayed such that at least a portion of the first content overlaps the second content displayed on the second display, and at least a portion of the first content is displayed without overlapping the second content.

14. The multi-layer display system of claim 10, wherein the first display and the second display each include a plurality passive white (W) liquid crystal display cells.

15. The multi-layer display system of claim 10, wherein the second display includes a common electrode provided on a side of the liquid crystal display cells opposite to the side adjacent to the second filter layer, and wherein the common electrode is disposed between the liquid crystal display cells and data and gate lines coupled to thin film transistors.

16. The multi-layer display system of claim 15, wherein the first display includes a common electrode provided on a side of the liquid crystal display cells opposite to the side including the first filter layer, and wherein the common electrode in the first display is disposed between the liquid crystal display cells of the first display and data and gate lines coupled to thin film transistors of the first display.

17. An instrument panel comprising;
a multi-layer display including a plurality of display panels arranged in a substantially parallel manner, the plurality of display panels including a rear display panel and a front display panel overlapping the rear display panel, each of the display panels including active red (R) sub-pixels, active green (G) sub-pixels, and active blue (B) sub-pixels, wherein active regions of the red (R) sub-pixels, green (G) sub-pixels, and blue (B) sub-pixels of the front display panel are larger than active regions of the red (R) sub-pixels, green (G) sub-pixels, and blue (B) sub-pixels of the rear display panel;
the multi-layer display further comprising a pair of crossed polarized layers, a first polarized layer of the pair of crossed polarized layers provided in front of and adjacent to the front display panel and a second polarized layer of the pair of crossed polarized layers provided behind and adjacent to the rear display panel;
a backlight configured to provide light to the front display panel and the rear display panel of the multi-layer display; and
a processing system comprising at least one processor and memory, the processing system configured to simultaneously display content on the plurality of display panels.

18. The instrument panel of claim 17, wherein at least one of the plurality of display panels is a monochrome panel.

19. The instrument panel of claim 17, wherein each of the plurality of display panels includes a color filter layer defining regions of the red (R) sub-pixels, active green (G) sub-pixels, and active blue (B) sub-pixels, and at least one of the plurality of display panels is provided without a black mask in color filter layer.

20. The instrument panel of claim 17, wherein the front display panel includes an opaque mask defining the active regions of the red (R) sub-pixels, green (G) sub-pixels, and blue (B) sub-pixels of the front display panel, and the rear display panel includes a transparent mask defining the active regions of the red (R) sub-pixels, green (G) sub-pixels, and blue (B) sub-pixels of the rear display panel.

21. The instrument panel of claim 17, wherein only the front display panel of the plurality of display panels includes a black mask defining the active regions of the red (R) sub-pixels, green (G) sub-pixels, and blue (B) sub-pixels of the front display panel.
